(19) United States
(12) Patent Application Publication
(10) Pub. No.: US 2016/0004625 A1
(43) Pub. Date: Jan. 7, 2016

(54) METHOD OF EXECUTING TEST SCRIPTS BASED ON RUNTIME TEST SELECTION

(71) Applicant: Sunil Mallaraju Gugri, Bangalore (IN)

(72) Inventor: Sunil Mallaraju Gugri, Bangalore (IN)

(73) Assignee: Unisys Corporation, Blue Bell, PA (US)

(21) Appl. No.: 14/562,900

(22) Filed: Dec. 8, 2014

(30) Foreign Application Priority Data
Jul. 7, 2014 (IN) 1867/DEL/2014

(51) Int. Cl. G06F 11/36

(52) U.S. Cl. CPC G06F 11/3684

(57) ABSTRACT

A method for selection of test scripts for testing a computer application. The method comprises selecting for each of one or more object types corresponding to the computer application, one or more first test scripts that cover all objects in the application corresponding to the one or more object types, executing the one or more first test scripts to test functionality of the objects corresponding to the one or more object types, assigning a test script a failed status in response to a test script error. The method further includes determining whether the test script error occurred due to an error in functionality of an object, selecting one or more second test scripts that refer to the object associated with the error in functionality of the object, and assigning the failed status to the one or more second test scripts without execution of the one or more second test scripts.

### TECHNICAL FIELD

The present application relates generally to testing software under development and more particularly to test script selection and execution.

### BACKGROUND

Software developers often develop software code in distributed-computing environments where networked computing devices may have diverse operating systems, software modules, hardware, firmware, and among other variations between components that may adversely affect compatibility of the code being developed. Similarly, software developers must develop software compatible with a vast array of public and private-enterprise environments in which networked devices may have a diverse range of components adversely affecting compatibility. It is important to test the code being developed for software products to ensure that the code underlying the software will be compatible with various components of computing devices executing the code.

In many software development efforts, code development is often performed incrementally in the form of modular components of the software, sometimes referred to as classes, objects, or some other term of art depending upon the coding language being used that refers to its modules of code as representing a part of the whole software product. In this incremental development methodology, software code may be tested for efficient and effective performance as each smaller modular portion of the whole is completed. That is, smaller portions of code are often developed through testing before incorporating them into the whole. This incremental testing methodology contrasts with waiting to test the entire software application as whole, after completing the code in its entirety.

Software code is often developed and tested in systems having a software development environment, integrated development environment (IDE), software development kit (SDK), or similar computer programs providing robust programming and testing interfaces for developers. Development environments may have frameworks that allow portions of code to execute without having a complete software product, thereby facilitating testing small modules of code before the software is completed. If a testing framework is not designed properly, then collating and disseminating test results can be tedious and cumbersome.

Often, developers utilize small chunks of code, so-called scripts, as mechanisms for testing incremental code portions of the whole software. Running automated scripts across multiple platforms typically requires significant effort to individually load each of the testing scripts into each specific system having a type of platform, to then execute the test script. Often, loading and running these scripts is manually done by a developer, as opposed to being automatically selected and executed by a system. This manual task of executing test scripts across multiple platforms can be time consuming. Moreover, in some cases, this manual task may fail to find “bugs” in the code at an early stage in software development, causing longer setbacks since fixes implemented at later stages often requires more extensive efforts. As an example, sometimes test scripts may fail for one platform but work in another, so in many cases it is necessary to identify whether scripts fail across a variety of platforms. It can be time consuming for developers to execute test scripts on each platform, and in some cases the varying results may be overlooked by human-error. Manually selecting and executing test scripts can also be time consuming when there are more test scripts queued for execution across each platform than there are devices or developers available. Additionally, execution of numerous test scripts taxes the computing resources available to the test system.

What is needed is a way to automatically select test scripts for execution while minimizing computing resources in order to expedite the overall testing process.

### SUMMARY

The systems and methods disclosed herein attempt to address the above-mentioned shortcomings in the art, and provide a variety of other benefits. The systems and methods described herein can facilitate testing code and quickly finding bugs across diverse computing platforms. Some embodiments may also keep track of each failed tests to reduce the time required for testing.

In one embodiment, a computer-implemented method is provided for selection of test scripts for testing a computer application in an object-oriented computer programming system environment. The method comprises selecting, by the test server, for each of one or more object types corresponding to the computer application, one or more first test scripts that cover all objects in the application corresponding to the one or more object types, executing, by the test server, the one or more first test scripts to test functionality of the objects corresponding to the one or more object types, and assigning a test script a failed status in response to a test script error, and determining whether the test script error occurred due to an error in functionality of an object. The method further includes selecting, by the test server, one or more second test scripts that refer to the object associated with the error in functionality of the object, and assigning, by the test server, the failed status to the one or more second test scripts without execution of the one or more second test scripts.

In another embodiment, a system is provided for selection of test scripts for testing a computer application in an object-oriented computer programming system environment. The system comprises an object repository including a computer readable storage medium having stored therein information associated with one or more objects of the computer application, and a test server, coupled to the object repository via a network, including a processor executing computer readable instructions for selection of the test scripts. The instructions include selecting for each of one or more object types corresponding to the computer application, one or more first test scripts that cover all objects in the application corresponding to the one or more object types, executing the one or more first test scripts to test functionality of the objects corresponding to the one or more object types, and assigning a test script a failed status in response to a test script error, determining whether the test script error occurred due to an error in functionality of an object, selecting one or more second test scripts that refer to the object associated with the error in functionality of the object, and assigning the failed status to the one or more second test scripts without execution of the one or more second test scripts.

In yet another embodiment, a non-transitory computer readable medium is provided having stored therein instructions to be executed by a processor for selection of test scripts for testing a computer application in an object-oriented computer programming system environment. The instructions comprising selecting, by the processor, for each of one or more object types corresponding to the computer application, one or more first test scripts that cover all objects in the application corresponding to the one or more object types, executing, by the processor, the one or more first test scripts to test functionality of the objects corresponding to the one or more object types, and assigning a test script a failed status in response to a test script error, determining, by the processor, whether the test script error occurred due to an error in functionality of an object, selecting, by the processor, one or more second test scripts that refer to the object associated with the error in functionality of the object, and assigning, by the processor, the failed status to the one or more second test scripts without execution of the one or more second test scripts.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a diagram of a system for selecting and executing test scripts according to an exemplary embodiment.

FIG. 2 illustrates a diagram of a test server architecture for selecting and executing test scripts according to an exemplary embodiment.

FIG. 3 illustrates a flow chart showing steps for a method for selecting and executing test scripts according to an exemplary embodiment.

### DETAILED DESCRIPTION

Reference will now be made in detail to the preferred embodiments, examples of which are illustrated in the accompanying drawings. The embodiments described herein are intended to be exemplary. One skilled in the art recognizes that numerous alternative components and embodiments may be substituted for the particular examples described herein and still fall within the scope of the invention.

It should be appreciated scripts may refer to software development tools, software code, and other machine-readable files prepared to effectively test certain aspects of a larger software development project. Although test scripts are particularly useful in larger object-oriented software development efforts, it should be appreciated that test scripts, code, software, processes, and modules are not intended to be limiting to large object-oriented software.

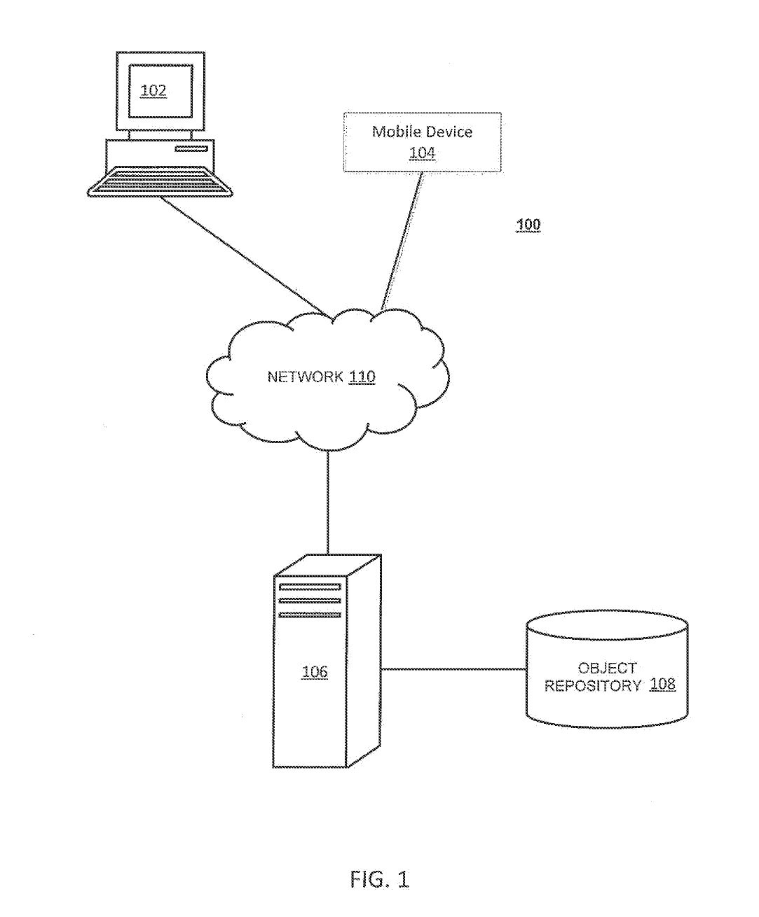

FIG. 1 is a diagram of an embodiment of a system environment 100 showing constituent parts of a system for selecting and executing test scripts across multiple platforms 102, 104, such as the desktop and mobile platform and respective operating systems. As shown in FIG. 1, a test server 106 communicates with respective client devices 102, 104 as well as with object repository 108 for executing a plurality of test scenarios that test the functionality of a new software application across the multiple platforms 102, 104. In the illustrated embodiment, the network 110, such as a Local Area Network (LAN) or a Wide Area Network (WAN) including the Internet, links the test server 104, client devices 102, 104 and/or the object repository 108. The object repository 108 includes a computer readable storage medium, such as a hard drive, a flash drive, RAM, or other non-transitory storage media, configured to store executable code modules corresponding to objects defined in the application subject to testing. As discussed in further detail below, one or more modules of the test server 106 cause execution, via a processor, of test scripts that test the functionality of the application code objects residing in the object repository 108. Preferably, the test server 106 selects test scripts for execution based on runtime test results of related objects, such as those belonging to the same object type. In one embodiment, the script execution takes place at a designated module of the test server 106, such as the Executor module discussed below, that is configured to implement various runtime environments and operating system platforms associated with the client devices 102, 104. Alternatively or in addition, the designated module of the test server 106 may cause execution of the test script directly at one or more client devices 102, 104.

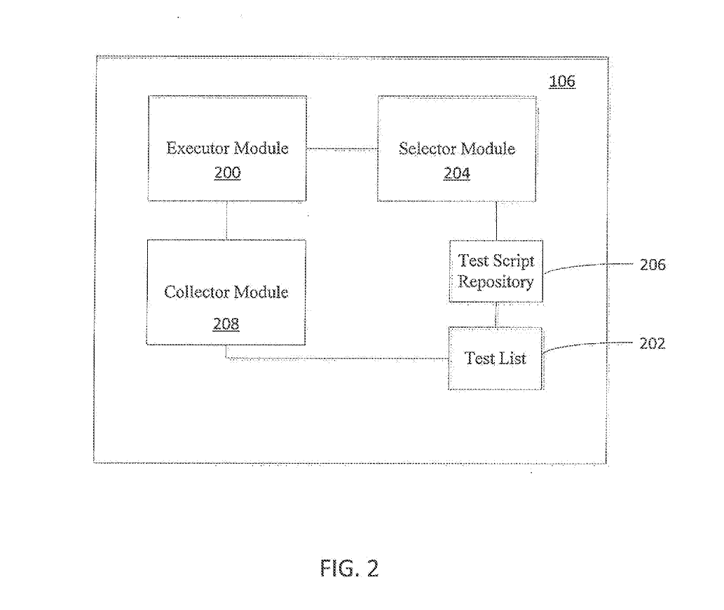

FIG. 2 illustrates an embodiment of the test server 106 in further detail. As those skilled in the art will realize, the test server 106 may include on or more physical servers disposed in the same or different geographic locations and connected via a network, such as the network 110 in FIG. 1. Furthermore various modules described below may form part of the same test server or be distributed among multiple test servers. As shown in FIG. 2, the test server 106 includes an Executor module 200 that receives user input of a total number of test scripts to be executed for the application that is subject to testing. Preferably, the system 100 stores test script names and corresponding test identification numbers in a test list 202, which may also be referred to as a test sheet. In an embodiment, the test list 202 is stored at the test server 106. Alternatively, the test list 202 is stored in a remote database.

As further discussed below, the system 100 updates the test sheet with a “passed” or “failed” status that becomes associated with each test script by selectively executing scripts referring to same objects until occurrence of an error attributed to testing the functionality of such common objects. The Executor module 200 interfaces with the Selector module 204 for selecting scripts for execution. For a given object type of the application, the Selector module 204 selects for execution from the test sheet a minimum number of test scripts that cover all objects of the same type that are stored in the object repository 108. The Executor module 200 receives the set of scripts selected for execution by the Selector module 204. Selected scripts are invoked for execution from a script repository 206. The “passed” or “failed” status of each test script is updated at the test list 202. Scripts that do not result in errors during execution are designated with a “passed” status in the test list 202, while scripts that result in errors are designated as “failed.” The status of scripts that failed due to an object error is passed on to the Collector module 208, which refers to the object repository to select additional test scripts that refer to the same object. The Collector module 208 then designates such additional scripts that refer to the object that failed during execution of another script as “failed” without executing such scripts. Foregoing the execution of test scripts that refer to the object that resulted in an error during execution of another script and labeling such scripts as “failed” has the effect of quickly identifying errors and reducing the computing time and resource requirements. In an embodiment, if script execution fails due to an unexpected error unrelated to object functionality, such script is assigned a “failed” status, however execution of other scripts that refer to the same object continues, including of scripts that may refer to an inner object associated with the object in the failed script.

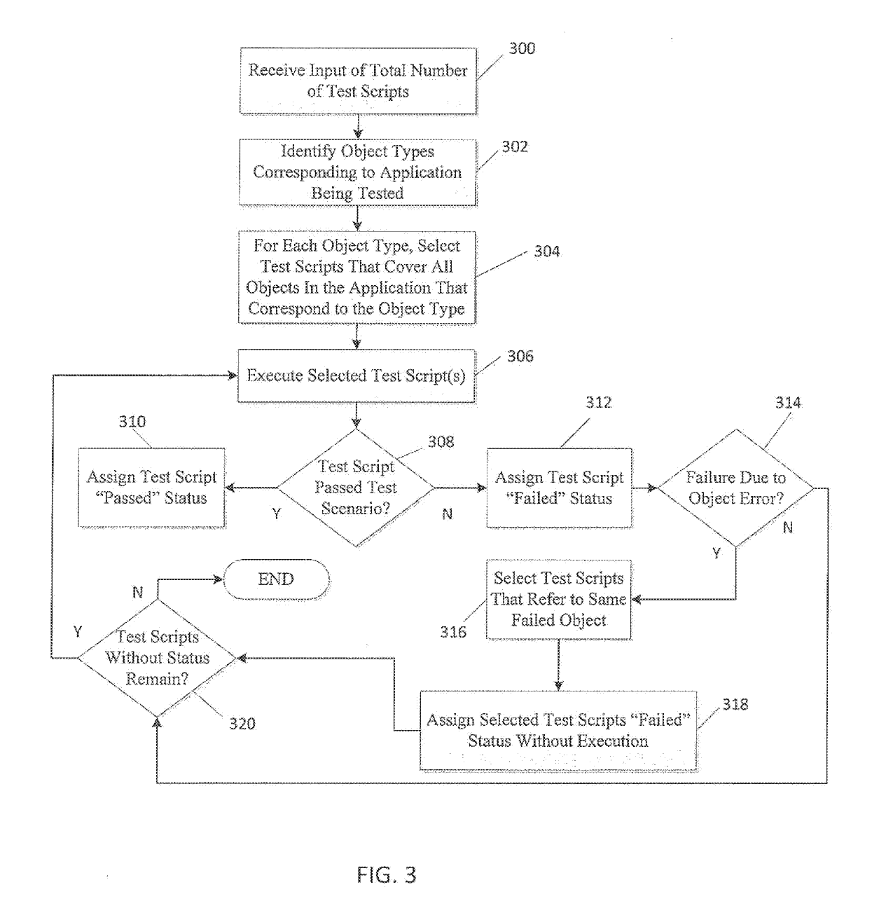

FIG. 3 is a flow chart showing steps for an exemplary test script selection method according to an embodiment of the disclosed subject matter. In step 300, the Executor module 200 of the test server 106 receives input, such as user input from a developer, of the total number of test scripts to be executed for the application under testing. In steps 302-304, upon identification of object types associated with the application, for each object type, the Selector module 204 selects test scripts that cover all corresponding objects. For example, if the application code includes a window object and inside the window there are two inner objects referring to respective window buttons, then there are three object types to be tested—namely one object type and two inner object types. In step 306, the selected test scripts are passed on to the Executor module 200 for execution. In various embodiments, the Executor module 200 executes selected scripts in sequential or non-sequential order (e.g., based on an ordering including based on file size, file name, random, or other ordering). In steps 308-310, if the executed test script did not result in one or more errors (i.e., passed the test scenario in the test script), the test script is assigned a “passed” status in the test list 202. Otherwise, in step 312, the test script is assigned a “failed” status. In step 314, when test script failure was due to an object error, the Collector module 208 refers to the object repository and selects additional test scripts that refer to the failed object in their code. To conserve time and computing resources, such additional selected test scripts that refer to the same failed object are not executed but marked as “failed” in the test list, steps 316-318. If, on the other hand, in step 314, the tested object code functionality was successful, but the test script execution still generated an unrelated unexpected error, then execution of any remaining test scripts, whether or not they refer to the same failed object, continues after checking whether test scripts without assigned status still remain on the test list, step 320. A similar check is performed after step 318 with respect to any remaining test scripts that have not been assigned a status and do not refer to the same failed object.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein. While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for selection of test scripts for testing a computer application in an object-oriented computer programming system environment, the method comprising:
selecting, by a test server, for each of one or more object types corresponding to the computer application, one or more first test scripts that cover all objects in the computer application corresponding to the one or more object types;
executing, by the test server, the one or more first test scripts to test functionality of the objects corresponding to the one or more object types, and assigning a test script a failed status in response to a test script error;
determining, by the test server, whether the test script error occurred due to an error in functionality of an object;
selecting, by the test server, one or more second test scripts that refer to the object associated with the error in functionality of the object; and
assigning, by the test server, the failed status to the one or more second test scripts without execution of the one or more second test scripts.

2. The method of claim 1 wherein the test server sequentially executes the one or more first test scripts.

3. The method of claim 1 further comprising:
determining that the error is unrelated to the functionality of the object; and
continuing executing test scripts that refer to the object that is unrelated to the error.

4. The method of claim 1 wherein the one or more first test scripts are selected to a test list, the method further comprising determining whether one ore more additional test scripts without assigned status remain on the test list.

5. The method of claim 1 wherein the test server is in communication with an object repository.

6. The method of claim 1 wherein the test server includes a test script repository.

7. A system for selection of test scripts for testing a computer application in an object-oriented computer programming system environment, the system comprising:
an object repository including a computer readable storage medium having stored therein information associated with one or more objects of the computer application;
a test server, coupled to the object repository via a network, including a processor executing computer readable instructions for selection of the test scripts, the instructions including:
selecting for each of one or more object types corresponding to the computer application, one or more first test scripts that cover all objects in the application corresponding to the one or more object types;
executing the one or more first test scripts to test functionality of the objects corresponding to the one or more object types, and assigning a test script a failed status in response to a test script error;
determining whether the test script error occurred due to an error in functionality of an object;
selecting one or more second test scripts that refer to the object associated with the error in functionality of the object; and
assigning the failed status to the one or more second test scripts without execution of the one or more second test scripts.

8. The system of claim 7 wherein the test server sequentially executes the one or more first test scripts.

9. The system of claim 7 wherein the instructions further include:
determining that the error is unrelated to the functionality of the object; and
continuing executing test scripts that refer to the object that is unrelated to the error.

10. The system of claim 7 wherein the one or more first test scripts are selected to a test list, the instructions further including determining whether one ore more additional test scripts without assigned status remain on the test list.

11. The system of claim 7 wherein the test script server includes a test script repository.

12. A non-transitory computer readable medium having stored therein instructions to be executed by a processor for selection of test scripts for testing a computer application in an object-oriented computer programming system environment, the instructions comprising:
selecting, by the processor, for each of one or more object types corresponding to the computer application, one or more first test scripts that cover all objects in the application corresponding to the one or more object types;
executing, by the processor, the one or more first test scripts to test functionality of the objects corresponding to the one or more object types, and assigning a test script a failed status in response to a test script error;
determining, by the processor, whether the test script error occurred due to an error in functionality of an object;
selecting, by the processor, one or more second test scripts that refer to the object associated with the error in functionality of the object; and
assigning, by the processor, the failed status to the one or more second test scripts without execution of the one or more second test scripts.

13. The computer readable medium of claim 12 wherein a test server sequentially executes the one or more first test scripts.

14. The computer readable medium of claim 12 wherein the instructions further comprise:
determining that the error is unrelated to the functionality of the object; and
continuing executing test scripts that refer to the object that is unrelated to the error.

15. The computer readable medium of claim 12 wherein the one or more first test scripts are selected to a test list, the instructions further comprising determining whether one ore more additional test scripts without assigned status remain on the test list.

16. The computer readable medium of claim 13 wherein the test server is in communication with an object repository.

17. The computer readable medium of claim 13 wherein the test server includes a test script repository.
